(19) United States
(12) Patent Application Publication
(10) Pub. No.: US 2008/0056782 A1
(43) Pub. Date: Mar. 6, 2008

(54) Fixing device, image forming apparatus and sheet conveying device

(75) Inventor: Tomoya Hotani, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 11/897,126

(22) Filed: Aug. 29, 2007

(30) Foreign Application Priority Data
Aug. 30, 2006 (JP) 2006-234143

(51) Int. Cl. G03G 15/20

(52) U.S. Cl. 399/323

(57) ABSTRACT

A fixing device is provided with a heating rotator for heating a transfer material, a pressurizing rotator held in contact with the heating rotator at a specified pressure to form a nip portion, a separating member made of a plate-like elastic body and adapted to separate the transfer material discharged from the nip portion from the heating rotator and/or pressurizing rotator, and a separating-member holder for positioning and holding the separating member at a discharge side of the nip portion. This separating-member holder holds the separating member utilizing a repulsive force resulting from an elastic deformation with the separating member elastically deformed.

### BACKGROUND OF THE INVENTION

1. The present invention relates to a fixing device and a sheet conveying device used in an image forming apparatus such as a copier, printer or facsimile machine.

2. Description of the Related Art. In an electrophotographic image forming apparatus such as a copier, printer or facsimile machine, a fixing device is used which is designed to fix a toner image formed on a photoconductive drum as an image bearing member and transferred to a recording sheet such as a copy sheet, which is a transfer material (recordable element), to the recording sheet by applying heat and pressure to the recording sheet (see, for example, Japanese Unexamined Patent Publication No. H06-32516).

FIG. 20 is a schematic section of a conventional fixing device disclosed in the above patent publication. A fixing device 800 shown in FIG. 20 includes a heat roller 810 having a heat source 811 such as a halogen lamp inside and heated to a specified temperature, a pressure roller 820 disposed in parallel with the heat roller 810 and held in contact with the heat roller 810 at a specified pressure, a separator 830 for separating a recording sheet from the heat roller 810 and a housing 840 covering the heat roller 810.

The recording sheet having the toner image transferred thereto is inserted into the fixing device 800 in a direction shown by an arrow W in FIG. 20, and held in a nip portion formed by contact surfaces of the heat roller 810 and pressure roller 820. The recording sheet is heated and pressurized in the nip portion to fix the transferred toner image to the recording sheet. The recording sheet having the toner image fixed thereto is discharged from the nip portion, but is winding around the heat roller 810. The separator 830 is fixed to the housing 840 covering the heat roller 810, and separates the recording sheet winding around the heat roller 810 from the heat roller 810.

Next, the separator 830 is described. FIG. 21 is an enlarged view of the separator 830. The separator 830 shown in FIG. 21 includes a separating claw 831 as an elastic body and an L-shaped supporting member 832 for supporting and fixing the separating claw 831. An upper side of the supporting member 832 and the housing 840 is fixed by a screw 833. One end of the separating claw 831 is fixed to a lower side of the supporting member 832 by means of adhesive 834, and the other end thereof is resiliently held in contact with the outer circumferential surface of the heat roller 810.

The separating claw 831 comes into contact with the recording sheet winding around the heat roller 810 due to the toner particles melted by the heat of the heat roller 810, thereby separating the recording sheet winding around the outer circumferential surface of the heat roller 810 from the heat roller 810. The separated recording sheet is conveyed toward a discharge tray (not shown).

However, the aforementioned separator 830 requires many members such as the supporting member 832, screw 833 and adhesive 834 to fix the separating claw 831. Further, upon attaching the separating claw 831 to the supporting member 832 using the adhesive, precise positioning is necessary. Thus, there is a problem of taking a lot of time and labor to assemble and exchange the separator 830.

Further, since the separator 830 is located near the heat roller 810, there is a possibility of deteriorating an adhesive ability of the adhesive 834 by the heat of the heat roller 810. If vibration or external force acts on the separating claw 831 with the adhesive ability of the adhesive 834 deteriorated, there is a problem that the separating claw 831 is easily detached from the supporting member 832.

### SUMMARY OF THE INVENTION

An object of the present invention is to provide a fixing device, an image forming apparatus and a sheet conveying device in which a separating member (separating claw) can be easily assembled and exchanged and is not easily detachable.

In order to accomplish this object, one aspect of the present invention is directed to a fixing device, comprising a heating rotator for heating a transfer material; a pressurizing rotator held in contact with the heating rotator at a specified pressure to form a nip portion; a separating member made of a plate-like elastic body and adapted to separate the transfer material discharged from the nip portion from the heating rotator and/or pressurizing rotator; and a separating-member holder for positioning and holding the separating member at a discharge side of the nip portion, wherein the separating-member holder holds the separating member utilizing a repulsive force resulting from an elastic deformation with the separating member elastically deformed.

Another aspect of the present invention is directed to an image forming apparatus, comprising a photoconductive member; an exposure unit for forming an electrostatic latent image on the photoconductive member; a development unit for forming a developer image by attaching a developer to the electrostatic latent image; a transfer unit for transferring the developer image to a transfer material; and a fixing unit for fixing the developer image to the transfer material, wherein the fixing unit has the construction of the above fixing device.

Still another aspect of the present invention is directed to a sheet conveying device, comprising a conveyor member having a rotatable conveying surface capable of conveying a sheet while being held in close contact therewith; a separating member made of an elastic member and adapted to separate the sheet from the conveying surface; and a separating-member holder for positioning and holding the separating member at a sheet discharging side, wherein the separating-member holder holds the separating member utilizing a repulsive force resulting from an elastic deformation with the separating member elastically deformed.

### BRIEF DESCRIPTION OF THE DRAWINGS

FIG. 1 is a construction diagram showing an example of an image forming apparatus for forming a monochromatic image.

FIG. 2 is a perspective view of a fixing device according to a first embodiment of the present invention.

FIG. 3 is a perspective view showing an example of a separating claw.

FIG. 4 is a section of a fixing device according to the first embodiment along a plane passing the separating claw in a recording sheet discharging direction.

FIG. 5 is a perspective view enlargedly showing one of the separating claws shown in FIG. 2.

FIG. 6 is a perspective view of a fixing device according to a second embodiment of the present invention.

FIG. 7 is a section of a fixing device according to the second embodiment along a plane passing a separating claw in a recording sheet discharging direction.

FIG. 8 is a perspective view showing a separating plate according to a modification.

FIG. 9 is a perspective view of the fixing device according to the first embodiment fitted with the separating plate of FIG. 8.

FIG. 10 is a perspective view of the fixing device according to the second embodiment fitted with the separating plate of FIG. 8.

FIG. 11 is a section in the case where separating-claw holders are formed on a heat roller holding frame and a pressure roller holding frame.

FIG. 12A is a section of a separating-claw holder according to a modification, FIG. 12B is a top view of the separating-claw holder and FIG. 12C is a perspective view of the separating-claw holder.

FIGS. 13 to 17 are diagrams showing other fixing devices according to the present invention.

FIGS. 18 and 19 are diagrams schematically showing one embodiment of a sheet conveying device according to the present invention.

FIG. 20 is a schematic section of a conventional fixing device.

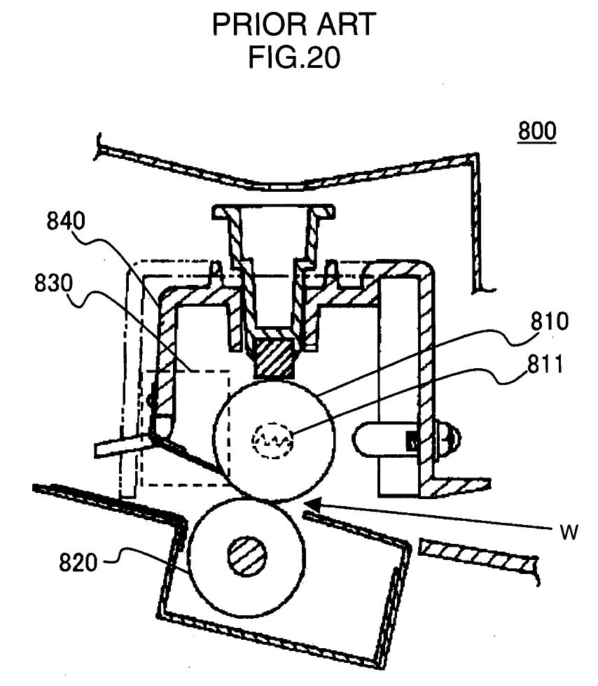

FIG. 21 is an enlarged view of a conventional separator.

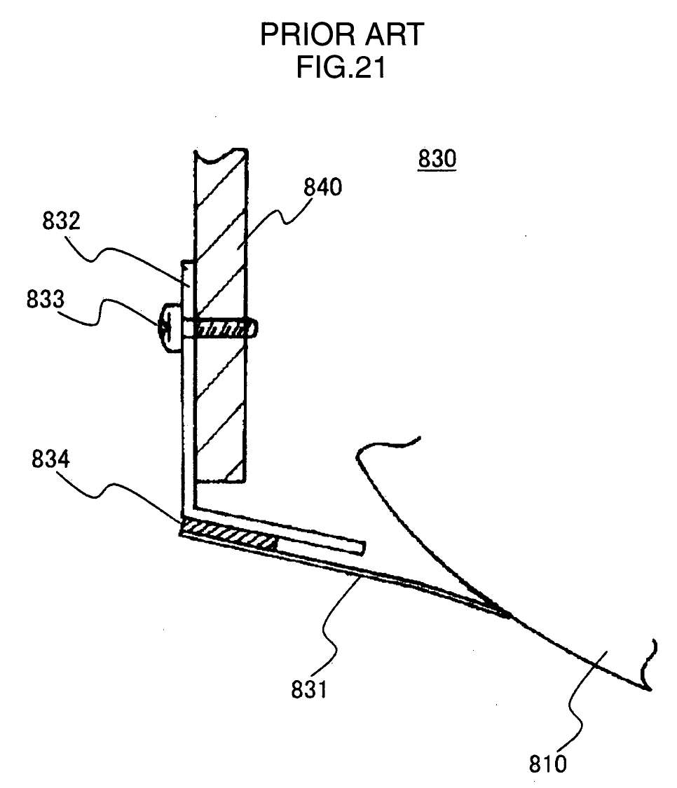

### DETAILED DESCRIPTION OF THE PREFERRED EMBODIMENTS

Hereinafter, embodiments of the present invention are described with reference to the accompanying drawings.

### First Embodiment

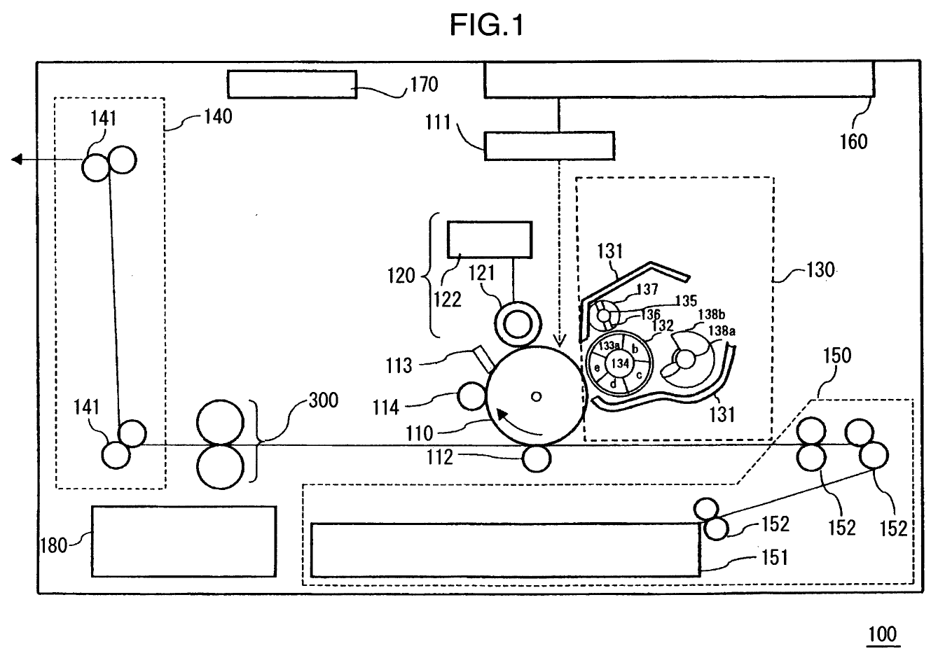

First, the construction of an image forming apparatus for forming a monochromatic image as an example of a conventional image forming apparatus is described. FIG. 1 is a schematic construction diagram showing an exemplary construction of an image forming apparatus. The image forming apparatus 100 shown in FIG. 1 is provided with an image forming mechanism in its central part.

The image forming mechanism includes a photoconductive drum 110, a charger 120 for charging the photoconductive drum 110, an exposing device 111 for forming an electrostatic latent image on the photoconductive drum 110, a developing device 130 for forming a toner image from the electrostatic latent image on the photoconductive drum 110, a transfer roller 112 for transferring the toner image to a transfer material, a cleaning blade 113 for removing a developer residual on the photoconductive drum 110, a cleaning roller 114 for rubbing the outer circumferential surface of the photoconductive drum 110, and a charge remover (not shown).

A fixing device 300 according to the first embodiment of the present invention is disposed downstream of the photoconductive drum 110 in a sheet conveying direction. Downstream of the fixing device 300 in the sheet conveying direction is disposed an unloading device 140 including a plurality of discharge rollers 141. A sheet feeding unit 151 is disposed below the image forming mechanism. Downstream of the sheet feeding unit 151 in a sheet feeding direction are arranged a plurality of feed rollers 152. The sheet feeding unit 151 and the feed rollers 152 construct a loading device 150.

The respective component parts of the image forming apparatus 100 shown in FIG. 1 are further described.

The charger 120 is a device disposed above the photoconductive drum 110 for uniformly charging the photoconductive drum 110. The charger 120 is comprised of a charging roller 121 and a voltage applier 122. The voltage applier 122 applies a bias voltage, in which a direct-current voltage and an alternating-current voltage are superimposed as a charging voltage, to the charging roller 121. The charging roller 121 charges the photoconductive drum 110 by the applied charging voltage.

The exposing device 111 forms an electrostatic latent image on the photoconductive drum 110 by exposing the outer circumferential surface of the photoconductive drum 110 based on an image data inputted from an image data input unit 160.

The developing device 130 is a device for forming a toner image by attaching toner particles to the electrostatic latent image formed on the outer circumferential surface of the photoconductive drum 110. The developing device 130 is comprised of a developer container 131, a developer carrier disposed in the developer container 131, a layer thickness restricting member and a spiral.

The developer carrier includes a cylindrical and rotatable developing roller 132 and magnetic field generating members 133a to 133e that are not in contact with the developing roller 132 and fixed inside the developing roller 132. The magnetic field generating members 133a to 133e form a cylindrical outer shape together by radially extending from a shaft member 134 as a center. The developing roller 132 rotates about the shaft member 134. A development bias is applied by a voltage application device (not shown) to the developing roller 132, which causes the charged toner to fly to the photoconductive drum 110.

The layer thickness restricting member includes a shaft 135, a magnetic field generating member 136 mounted on the center of the shaft 135, and a shape retaining member 137 having the shape of a hollow sleeve for accommodating the magnetic field generating member 136 and the shaft 135. The layer thickness restricting member has a cylindrical shape and is arranged in parallel with the developer carrier. The magnetic field generating member 136 is formed by a magnetic pole element (permanent magnet) and so constructed as not to touch the shape retaining member 137. Since the magnetic field generating member 136 is opposed to the developing roller 132 via the shape retaining member 137, the toner particles does not directly adhere to the outer surface thereof.

The spiral includes a shaft 138a and a spiral blade 138b formed around the shaft 138a, and agitates the toner particles contained in the developer container 131 by rotating about the shaft 138a.

The transfer roller 112 transfers the toner image formed on the photoconductive drum 110 to a transfer material such as a sheet. After the toner image is transferred to the transfer material, the cleaning blade 113 functions to clean adhered matters such as residual developer remaining on the photoconductive drum 110. The cleaning roller 114 rubs the outer circumferential surface of the photoconductive drum 110 by coming into contact with the outer circumferential surface of the photoconductive drum 110, and functions as a buffer for collecting and discharging the toner particles.

The fixing device 300 is a device for fixing the toner image transferred to the transfer material to the transfer material.

The image data input unit 160 is an interface for receiving a data input from an external apparatus such as an optical reading mechanism or PC. An imaging condition setting unit 170 is an interface for receiving an external user input, and sets parameters such as the magnification and density of an image to be transferred to the transfer material.

A power supply device 180 is a device for supplying power to the photoconductive drum 110, charger 120, exposing device 111, developing device 130, transfer roller 112, fixing device 300, charge remover, unloading device 140, loading device 150, image data input unit 160 and imaging condition setting unit 170, and is connected with the respective component parts by unillustrated power supply lines and control signal lines.

The fixing device 300 according to the first embodiment for fixing the toner image to the transfer material at a final stage in the image forming apparatus 100 having the construction as above is described in detail.

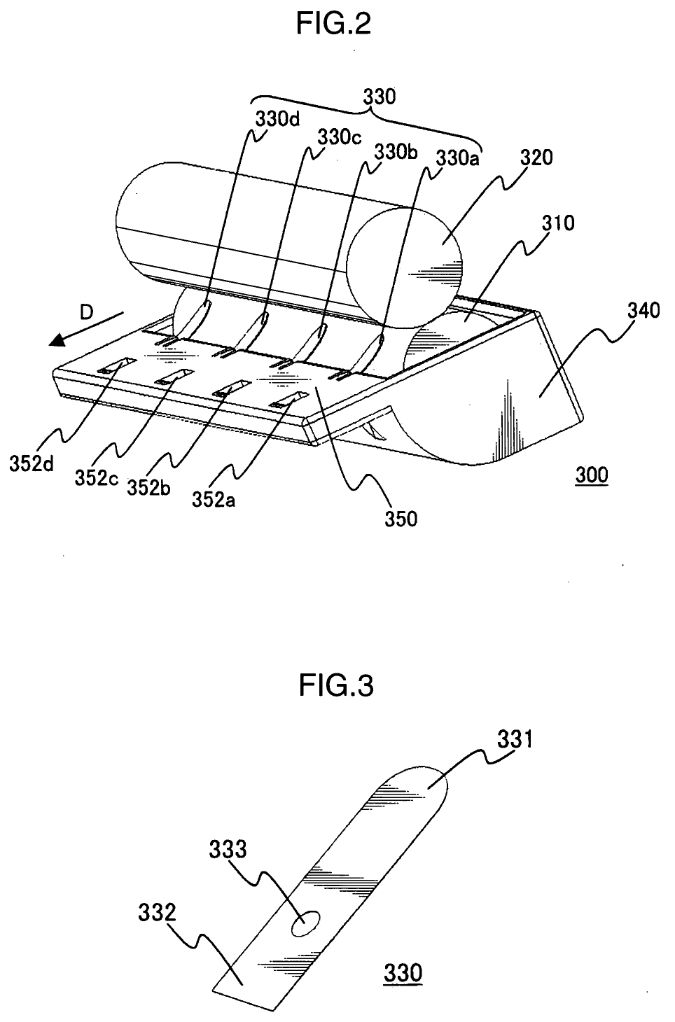

FIG. 2 is a perspective view of the fixing device 300 according to the first embodiment. This fixing device 300 is provided with a heat roller 310 (heating rotator) having a heat source such as a halogen lamp inside, a pressure roller 320 (pressurizing rotator) for coming into contact with the heat roller 310 at a specified pressure, separating claws 330a to 330d (separating member) for separating a recording sheet P winding around the heat roller 310 from the heat roller 310, a heat-roller holding frame 340 (heating-rotator holding frame) for rotatably holding the heat roller 310, and a separating-claw holder 350 (separating-member holder) for holding the separating claws 330a to 330d. It should be noted that other component parts such as a pressure-roller holding frame for rotatably holding the pressure roller 320 are not shown in FIG. 2. An arrow D in FIG. 2 denotes a sheet discharging direction.

The heat roller 310 and pressure roller 320 are arranged such that the rotary shafts thereof are parallel to each other. The heat-roller holding frame 340 rotatably holds the heat roller 310. The pressure roller 320 is held in contact with the heat roller 310 at a specified pressure, whereby a nip portion is formed by contact surfaces of both rollers.

Each of the separating claws 330a to 330d is arranged in parallel with a sheet discharging side of the heat roller 310 with one end (first end facing toward the nip portion) thereof held in contact with the heat roller 310.

The separating-claw holder 350 is integrally formed with the heat-roller holding frame 340 at a sheet discharging side of the hating-roller holding frame 340 (discharging side of the nip portion). The separating-claw holder 350 is provided with insertion spaces 352a to 352d. The details of the separating-claw holder 350 including the insertion spaces 352a to 352d are described later.

Since the heat roller 310, pressure roller 320 and heat-roller holding frame 340 are similar to those of prior art, they are not described in detail.

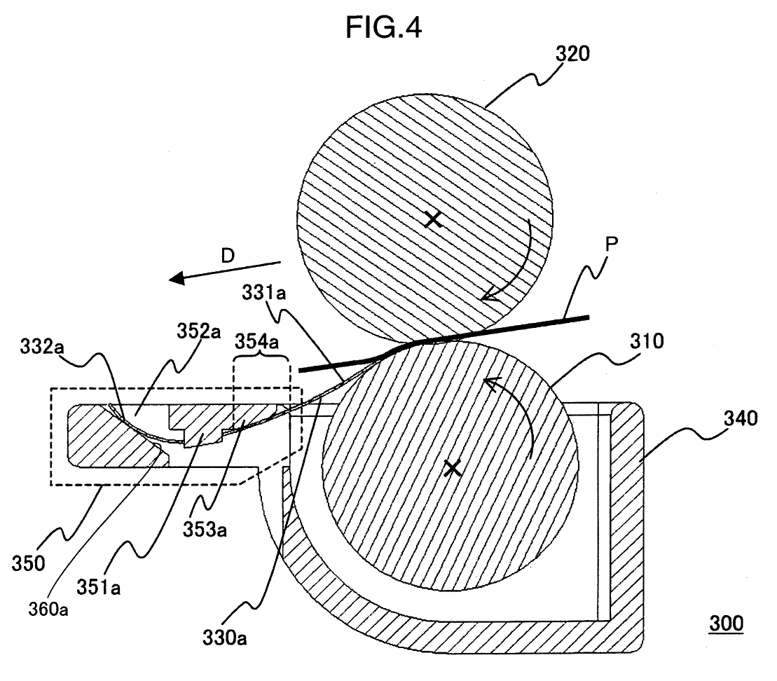

Next, the separating claws 330a to 330d are described. FIG. 3 is a perspective view of the separating claw 330 detached from the separating-claw holder 350. As shown in FIG. 3, the separating claw 330 is in the form of a narrow thin plate having an arcuate right upper end and a remaining part with a constant width.

The right upper end of the separating claw 330 in FIG. 3 is a separating end 331 (first end) held in contact with the rotating surface of the heat roller 310. The separating end 331 is a part for separating the heat roller 310 and the recording sheet P winding around the heat roller 310. The separating end 331 has an arcuate shape so as to easily touch the recording sheet P. The left lower end of the separating end 330 in FIG. 3 is an insertion end 332 (second end) to be inserted into the insertion space 352a to 352d formed in the separating-claw holder 350.

Further, a round through hole 333 is formed between the separating end 331 and insertion end 332 of the separating claw 330. The through hole 333 functions to determine the mount position of the separating claw 330 upon mounting the separating claw 330 in the separating-claw holder 350.

The separating claw 330 is formed of an elastic body in order to be held in contact with the heat roller 310 at the specified pressure as described above. Specifically, the separating claw 330 is formed of a stainless-steel plate having fluororesin applied or adhered to the outer surface thereof. An exemplary outer shape of the separating claw 330 has a width of 5 mm, a length of 30 mm and a thickness of 0.03 to 0.1 mm.

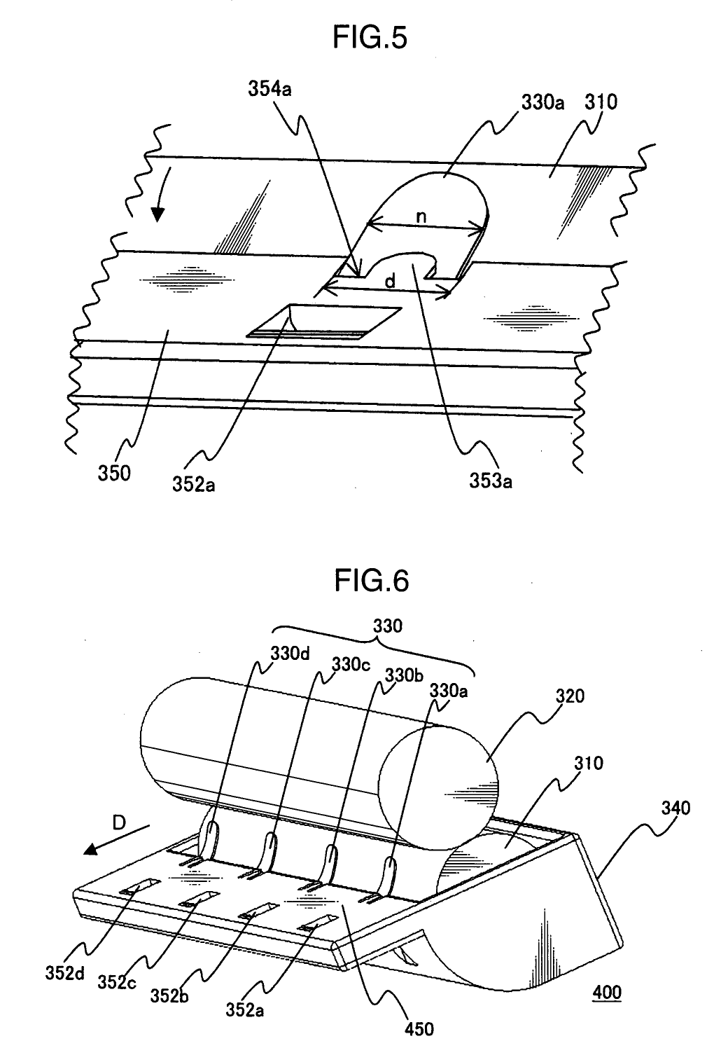

Next, the separating-claw holder 350 is described with reference to FIG. 4. FIG. 4 is a section of the fixing device 300 shown in FIG. 2 along a plane passing the separating claw 330a in the sheet discharging direction (arrow D).

As shown in FIG. 4, the separating-claw holder 350 includes a positioning projection 351a (projection) for determining the mount position of the separating claw 330a, the insertion space 352a for the insertion of the insertion end 332a of the separating claw 330a, an adjusting projection 353a (pressing force adjusting portion) for adjusting a pressing force of the separating claw 330a against the rotating surface of the heat roller 310, and a groove 354a formed in the upper surface of the separating-claw holder 350 for restricting the contact of the separating claw 330a and the upper surface of the separating-claw holder 350. Although the separating-claw holder 350 is shown to hold only the separating claw 330a in FIG. 4, positioning projections, insertion spaces, adjusting projections and grooves for holding the separating claws 330b to 330d are actually formed in the separating-claw holder 350 as in FIG. 4.

Next, a state of the separating-claw holder 350 holding the separating claws 330 is described, taking the separating claw 330a as an example. As shown in FIG. 4, the separating claw 330a is held in the separating-claw holder 350 in such an arched state where the separating end 331a is in contact with the rotating surface of the heat roller 310. In other words, the separating claw 330a is held in the separating-claw holder 350 while being elastically deformed.

The positioning projection 351a is fittable into the through hole 333a of the separating claw 330a. By the engagement of the through hole 333a of the separating claw 330a and the positioning projection 351a, the separating claw 330a has the mount position thereof determined and is prevented from moving in the sheet discharging direction.

The insertion space 352a is a space formed to the left of the positioning projection 351a in FIG. 4. The width of the insertion space 352a substantially coincides with that of the insertion end 332a while providing a clearance of such a degree as to enable the insertion end 332a of the separating claw 330a into the insertion space 352a. By the insertion of the insertion end 332a of the separating claw 330a into the insertion space 352a from the side of the positioning projection 351a, the separating claw 330a is prevented from moving in a direction perpendicular to the sheet discharging direction and a part thereof between the insertion end 332a and through hole 333a is arched.

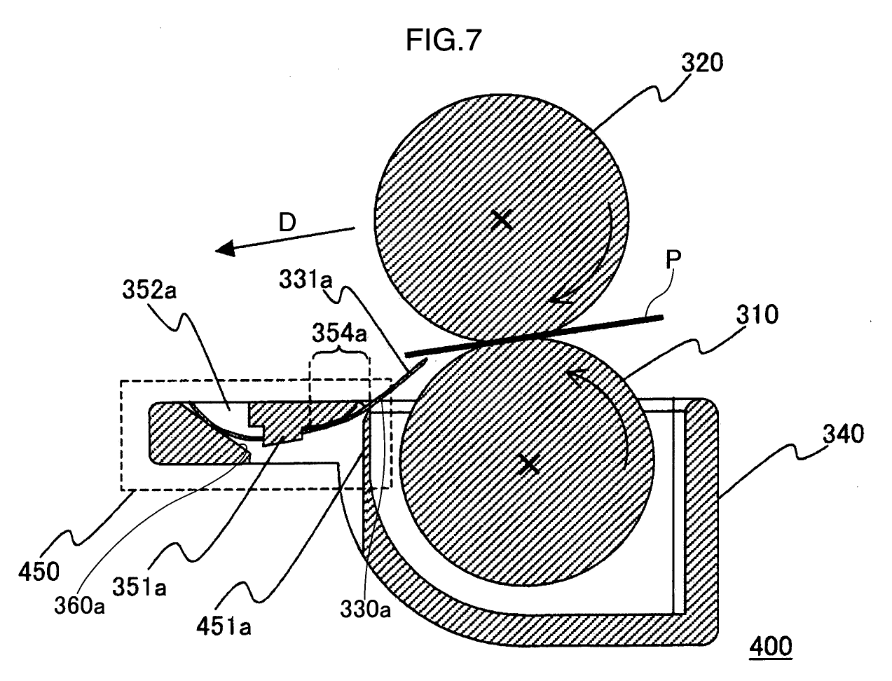

More specifically, the insertion space 352a is formed by a vertical through hole made in a frame member constructing the separating-claw holder 350. This through hole has a rectangular opening at its upper side (see FIG. 5), and includes an inclined side wall 360a (first receiving portion) inclined downward toward the direction of a nip portion side as one side wall defining the through hole. The insertion end 332a biased with a repulsive force resulting from the elastic deformation of the arched separating claw 330a rests on this inclined side wall 360a.

The adjusting projection 353a is a projection disposed to the right of the positioning projection 351a in FIG. 4 and extending in a direction toward the heat roller 310. The adjusting projection 353a presses a part of the separating claw 330a between the separating end 331a and the through hole 333a toward the heat roller 310.

Thus, the part of the separating claw 330a between the separating end 331a and the through hole 333a is arched. The adjusting projection 353a can adjust the arched state of the separating claw 330a by adjusting the projecting length to change a pressing force of the separating claw 330a against the heat roller 310.

Since the separating claw 330a is arched, the separating end 331a presses the rotating surface of the heat roller 310 by an elastic force of the separating claw 330a. The pressing force of the separating claw 330a against the rotating surface of the heat roller 310 depends on the arched state of the separating claw 330a between the separating end 331a and the through hole 333a. In other words, the pressing force of the separating end 331a against the heat roller 310 can be adjusted by adjusting the projecting length of the adjusting projection 353a.

Next, the position of the adjusting projection 353a is described with reference to FIG. 5. FIG. 5 is an enlarged perspective view near the separating claw 330a shown in FIG. 2. As shown in FIG. 5, the adjusting projection 353a is formed in the groove 354a formed in the separating-claw holder 350. Width d of the groove 354a is larger than width n of the separating claw 330a.

By forming the groove 354a in the separating-claw holder 350, the separating claw 330a can project from the upper surface of the separating-claw holder 350 as shown in FIG. 5. In other words, the part of the separating claw 330a from the separating end 331a to the through hole 333a is not in contact with the separating-claw holder 350 except at the adjusting projection 353a. Accordingly, the arched state of the separating claw 330a can be adjusted only by the length of the adjusting projection 353a, wherefore the separating claw 330a can apply a desired pressing force to the rotating surface of the heat roller 310.

Next, a mounting method of the separating claw 330a is described with reference to FIG. 4. First, an operator inserts the separating claw 330a being arched into the separating-claw holder 350 from below in FIG. 4. Specifically, the operator brings the separating end 331 of the separating claw 330a into contact with the rotating surface of the heat roller 310 with the separating claw 330a arched, and inserts the insertion end 332a of the separating claw 330a into the insertion space 352a. At this time, the insertion end 332a is supported on the inclined side wall 360a.

Subsequently, the operator fits the positioning projection 351a into the through hole 333a of the separating claw 330a. In the above way, the separating claw 330a is mounted into the fixing device 300, utilizing its own elastic repulsive force generated by being arched, while being positioned by the through hole 333a.

As described above, the separating claw 330a can be mounted into the fixing device 300 of this embodiment without using any adhesive. Accordingly, the number of parts used upon mounting the separating claw 330a into the fixing device 300 can be reduced, and the separating claw 330a can be easily mounted.

Although the above description is made taking the separating claw 330a as an example, it similarly holds for the separating claws 330b to 330d.

Next, the operation of the fixing device according to this embodiment is described. The recording sheet P (transfer material) having the toner image transferred thereto by the transfer roller 112 is held in the nip portion formed by the contact surfaces of the heat roller 310 and pressure roller 320. In the nip portion, the unfixed toner image on the recording sheet P is fixed by the application of heat and pressure to the recording sheet P.

The recording sheet P having the toner image fixed thereto is discharged from the nip portion. However, when the recording sheet P is discharged from the nip portion, the recording sheet P is winding around the heat roller 310 because of the melted toner particles in the nip portion. The separating ends of the separating claws 330a to 330d separate the heat roller 310 and the winding recording sheet P by the contact with the recording sheet P winding around the heat roller 310. The separated recording sheet P is discharged to the unloading device 140 shown in FIG. 1.

### Second Embodiment

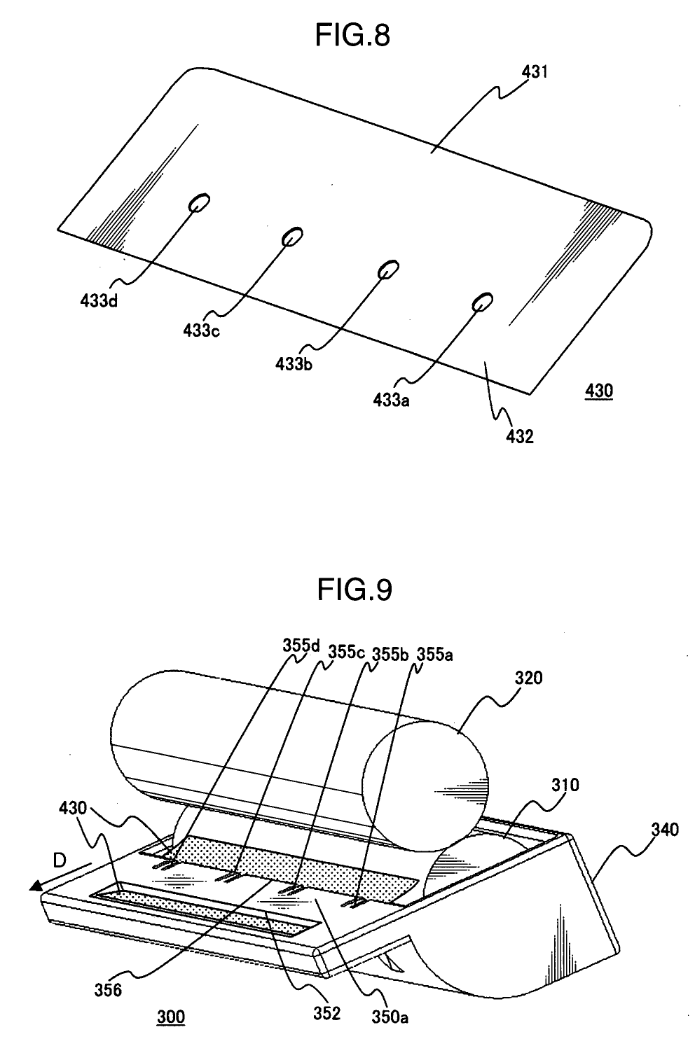

FIG. 6 is a perspective view of a fixing device according to a second embodiment of the present invention. A fixing device 400 shown in FIG. 6 is provided with a heat roller 310, a pressure roller 320, separating claws 330a to 330d, a heat-roller holding frame 340 and a separating-claw holder 450 for holding the separating claws 330a to 330d. It should be noted that component parts such as a pressure-roller holding frame for rotatably holding the pressure roller 320 are not shown in FIG. 6.

In the fixing device 400 shown in FIG. 6, the same component parts as those of the fixing device 300 of the first embodiment are not described by being identified by the same reference numerals.

First, main points of difference between the fixing device 400 of this embodiment and the fixing device 300 of the first embodiment are described. The separating ends of the separating claws 330a to 330d are in contact with the rotating surface of the heat roller 310 in the fixing device 300, whereas those of the separating claws 330a to 330d are not in contact with the rotating surface of the heat roller 310 in the fixing device 400. The following description of the fixing device 400 of the second embodiment is centered on points of difference from the fixing device 300.

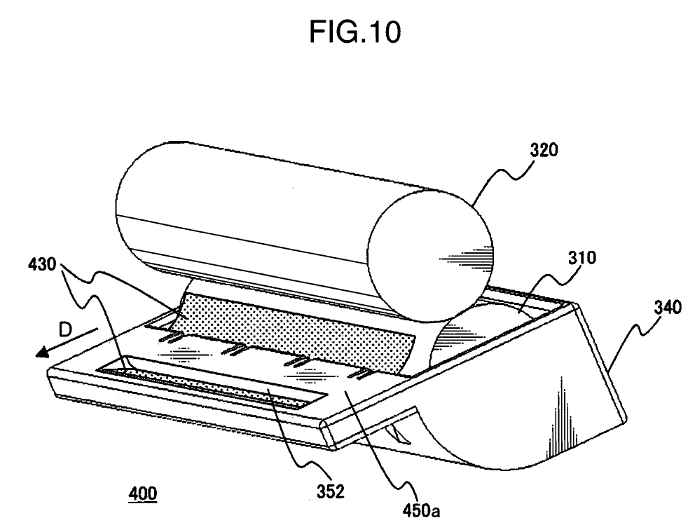

FIG. 7 is a section of the fixing device 400 shown in FIG. 6 along a plane passing the separating claw 330a in a sheet discharging direction. As shown in FIG. 7, the separating-claw holder 450 (separating-member holder) is similar to the separating-claw holder 350 in that the separating claw 330a is held arched. However, instead of the adjusting projection 353a shown in FIG. 4, the separating-claw holder 450 includes a restricting projection 451a (second receiving portion/restricting portion) for restricting the arched state of the separating claw 330a lest the separating end 331a of the separating claw 330a should touch the heat roller 310.

As shown in FIG. 7, the restricting projection 451a presses the separating claw 330a in a direction opposite to the one in which the adjusting projection 353a presses the separating claw 330a (see FIG. 4). In other words, the restricting projection 451a supports the separating end 331a of the separating claw 330a biased by a repulsive force resulting from an elastic deformation of the arched separating claw 330a.

Thus, the separating end 331a is not in contact with the heat roller 310 although a part of the separating claw 330a between the separating end 331a and through hole 333a is arched. In FIG. 7, a distance between the separating claw 330a and heat roller 310 is shown in an exaggerated manner, but the separating claw 330a and heat roller 310 are actually located closer to each other than in FIG. 7.

Similar to the separating-claw holder 350, the separating-claw holder 450 is formed with a groove 354a. This is to prevent the separating claw 330a pressed by the restricting projection 451 from coming into contact with the heat roller 310 or pressure roller 320 upon the contact with the separating-claw holder 450 other than at the restricting projection 451a.

Next, the operation of the fixing device 400 is described with reference to FIG. 7. The operation of the fixing device 400 until a recording sheet P is discharged from the nip portion after an unfixed toner image is fixed to the recording sheet P is not described since being similar to the operation of the fixing device 300. The recording sheet P discharged from the nip portion is winding around the heat roller 310. However, since no toner particles are transferred to a margin part of the recording sheet P, the margin part of the recording sheet P (peripheral part of the recording sheet P) is not winding around the heat roller 310. The separating claws 330a to 330d separate the heat roller 310 and the recording sheet P winding around the heat roller 310 by coming into contact with the margin part of the recording sheet P. The separated recording sheet P is discharged to the unloading device 140 shown in FIG. 1.

### (Description of Various Modifications)

The separating-claw holders 350 is described to include the adjusting projection and groove in the above first and second embodiments, but the present invention is not limited thereto and the separating-claw holder 350 may include neither the adjusting projection nor groove. In such a case, the pressing forces of the separating claws 330 toward the heat roller 310 can be changed by changing the thickness, material or the like of the separating claws 330.

Although one through hole is formed in each of the separating claws 330a to 330d in the above embodiments, the present invention is not limited thereto. For example, each of the separating claws 330a to 330d may be formed with two or more through holes.

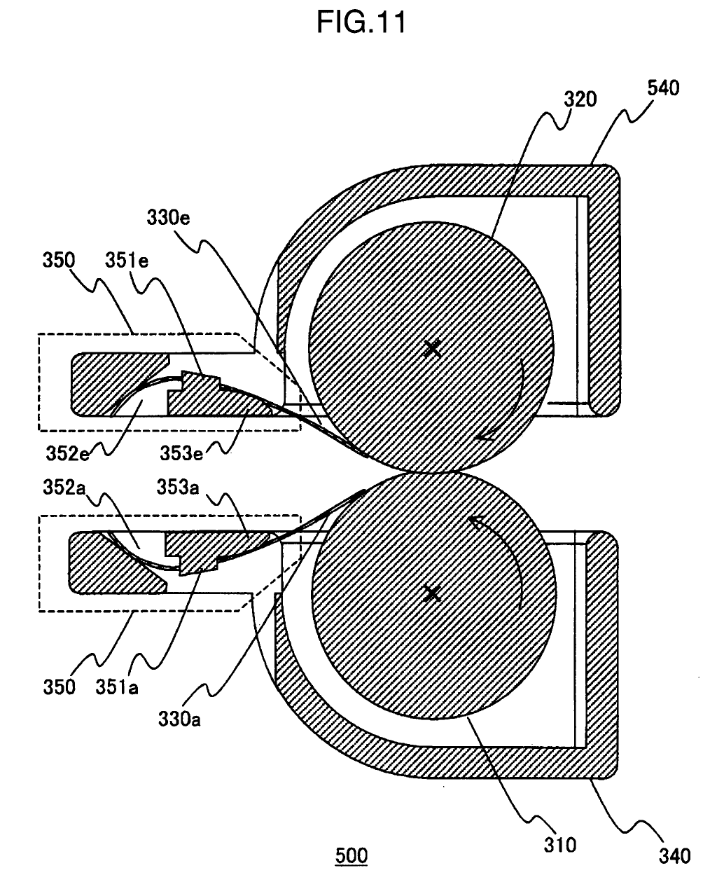

In the foregoing embodiment, the separating member is constituted by the plurality of narrow separating claws 330. The present invention is not limited to such separating member. For example, the separating member of the present invention may be a member in the form of a wide plate and having one or more through holes. Specifically, FIG. 8 is a perspective view of a wide separating plate having a plurality of through holes. The separating plate 430 shown in FIG. 8 includes four through holes 433a to 433d. One through hole may be formed in a separating plate without being restricted to the separating plate 430 shown in FIG. 8.

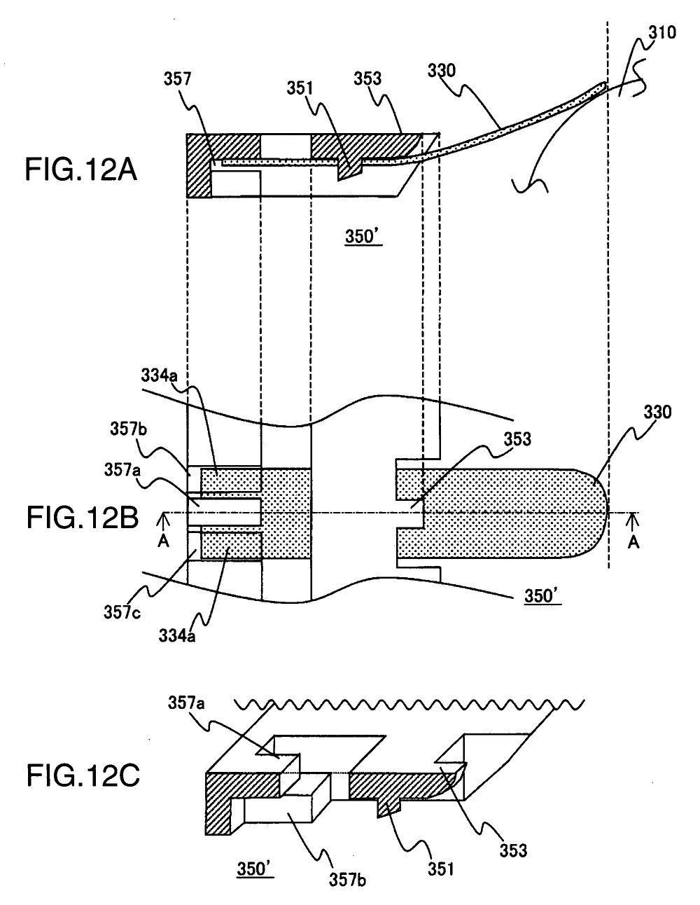

FIG. 9 is a perspective view of the fixing device 300 of the first embodiment fitted with the separating plate 430. As shown in FIG. 9, the separating-claw holder 350a may hold the separating plate 430 such that a separating end 431 of the separating plate 430 is in contact with the rotating surface of the heat roller 310. The width of the separating plate 430 substantially coincides with that of the heat roller 310. However, the width of the separating plate 430 needs not conform to that of the heat roller 310 as long as it conforms to the width of the recording sheet P discharged from the nip portion. Further, the four through holes 433a to 433d are arranged side by side in the width direction.

The separating-claw holder 350a shown in FIG. 9 is formed with only one insertion space 352 in conformity with the width of the separating plate 430, and an insertion end 432 of the separating plate 430 is inserted into the insertion space 352. In the separating-claw holder 350a shown in FIG. 9, a number of positioning projections corresponding to that of the through holes formed in the separating plate 430 are provided.

In the case of using the separating plate 430, the separating-claw holder 350a shown in FIG. 9 is provided with adjusting projections 355a to 355d projecting from an end 356 of the separating-claw holder 350 toward the heat roller 310. The separating-claw holder 350a shown in FIG. 9 can adjust a pressing force of the separating plate 430 toward the heat roller 310 by adjusting projecting amounts of the adjusting projections 355a to 355d from the end 356. Further, the separating-claw holder 350a shown in FIG. 9 may not include the adjusting projections 355a to 355d. In such a case, the pressing force of the separating plate 430 toward the heat roller 310 can be changed by changing the thickness, material or the like of the separating claws 330.

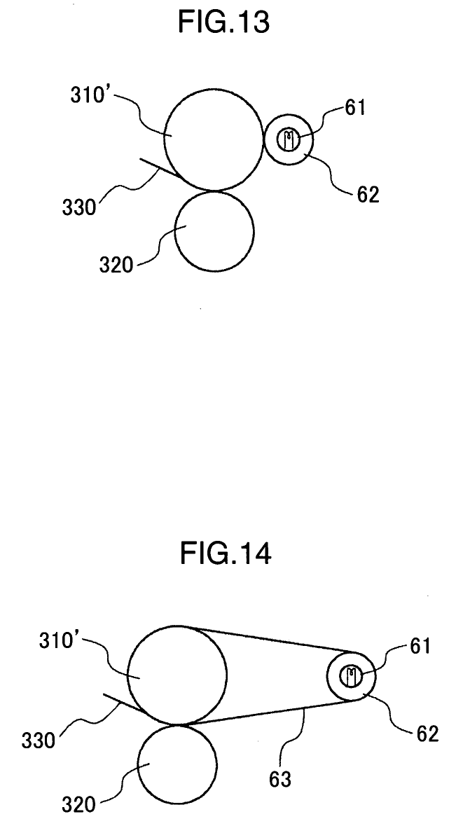

FIG. 10 is a perspective view of the fixing device 400 of the second embodiment fitted with the separating plate 430. As shown in FIG. 10, the separating-claw holder 450a holds the separating plate 430 such that the separating end 431 of the separating plate 430 is not in contact with the rotating surface of the heat roller 310. In this case, the separating-claw holder 450a is provided with only one insertion space 352 in conformity with the width of the separating plate 430. Further, a number of positioning projections corresponding to that of the through holes formed in the separating plate 430 are provided.

Although the separating-claw holder 350 or 450 is formed only in the heat-roller holding frame 340 in the above embodiments, the present invention is not limited thereto and the separating-claw holder 350 or 450 may be formed in each of the heat-roller holding frame 340 and the pressure-roller holding frame for rotatably holding the pressure roller 320.

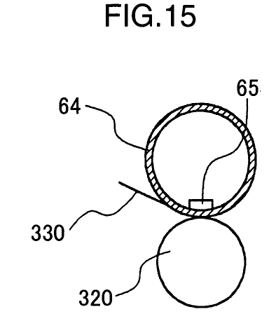

FIG. 11 is a section in the case of forming the separating-claw holder 350 in both the heat-roller holding frame and the pressure-roller holding frame. In a fixing device of an image forming apparatus capable of duplex printing, the fixed toner particles may be present on the recording sheet P at a side facing the pressure roller 320. Thus, there are cases where the recording sheet P winds around the pressure roller 320. In a fixing device 500 shown in FIG. 11, the separating-claw holder 350 is also formed in a pressure-roller holding frame 540 for rotatably holding a pressure roller 320, and includes a separating claw 330e.

Thus, even if the recording sheet P is winding around the pressure roller 320, the pressure roller 320 and the recording sheet P winding around the pressure roller 320 can be separated. Although FIG. 11 shows the example in which the separating-claw holder 350 is formed in the heat-roller holding frame 340 and pressure-roller holding frame 540, the separating-claw holder 450 may be formed in the heat-roller holding frame 340 and pressure-roller holding frame 540.

Although the separating claws 330 held in the separating-claw holders 350 and 450 are arched in their parts from the insertion ends 332 to the through holes 333 in the above embodiments, the present invention is not limited thereto and the parts of the separating claws 330 from the separating ends 331 to the through holes 333 may, for example, be arched.

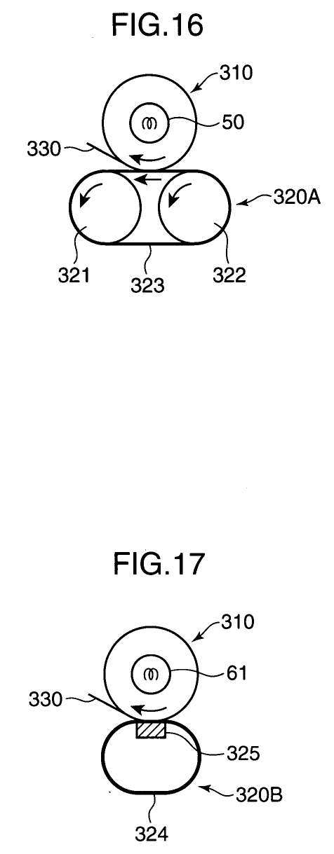

FIG. 12A is a section of a separating-claw holder 350′ as another example of the separating-claw holder 350, FIG. 12B is a top view of the separating-claw holder 350′ shown in FIG. 12A, and FIG. 12C is a perspective view of the separating-claw holder 350′ shown in FIG. 12A. The section of the separating-claw holder 350′ in FIGS. 12A and 12C is a section along A-A of FIG. 12B.

The separating-claw holder 350′ shown in FIG. 12A holds the separating claw 330 with the part of the separating claw 330 from the insertion end 332 to the through hole 333 held straight. Specifically, as shown in FIG. 12A, the fixing device of the present invention may hold the separating claw 330 with the part from the separating end 331 to the through hole 333 arched so that the separating claw 330 can apply a pressing force to the heat roller 310. Such a separating claw 330 can also be stably held by a repulsive force resulting from the elastic deformation thereof.

As shown in FIG. 12B, an insertion space 357 of the separating-claw holder 350′ is comprised of an upper restricting portion 357a for pressing a middle part of the insertion end 332 of the separating claw 330 from above the separating claw 330, a lower restricting portion 357b for pressing one of opposite end portions 334a of the insertion end 332 of the separating claw 330 from below, and a lower restricting portion 357c for pressing the other of the end portions 334a from below. If the part of the separating claw 330 from the separating end 331 to the through hole 333 is arched in this way, the insertion end 332 of the separating claw 330 may only be pressed from above and below in FIG. 12A so as not to move in vertical directions of FIG. 12A. The insertion space 357 shown in FIGS. 12A to 12C is also applicable to the separating-claw holder 450.

Although the through holes 333 of the separating claws 330 have a circular shape in the above embodiments, the present invention is not limited thereto. For example, the through holes 333 may have a rectangular shape. By forming the through holes 333 to have a rectangular shape, the separating-claw holder can restrict movements of the separating claws 330 by fitting the positioning projections into the through holes 333. In this case, the width of the insertion space 352 may be sufficiently wider than that of the insertion end 332 of the separating claw 330.

Although the heat roller 310 is a cylindrical roller in the above embodiments, the present invention is not limited thereto. For example, an endless flexible belt may be used instead of the heat roller 310. Similarly, an endless flexible belt may also be used instead of the pressure roller 320.

Although the four separating claws are provided in the fixing devices 300, 400 in the above embodiments, the present invention is not limited thereto. For example, one to three, five or more separating claws may be provided.

Although the stainless-steel plates are used as the base material of the separating claws 330 in the above embodiments, the present invention is not limited thereto. For example, the base material of the separating claws 330 may be phosphor bronze or polyimide resin. It other words, it is sufficient to make the separating claws 330 of an elastic and heat resistant material.

Although the separating-claw holder is formed to be integral to the heat-roller holding frame in the above embodiments, the present invention is not limited thereto and the separating-claw holder and the heat-roller holding frame may be separately formed.

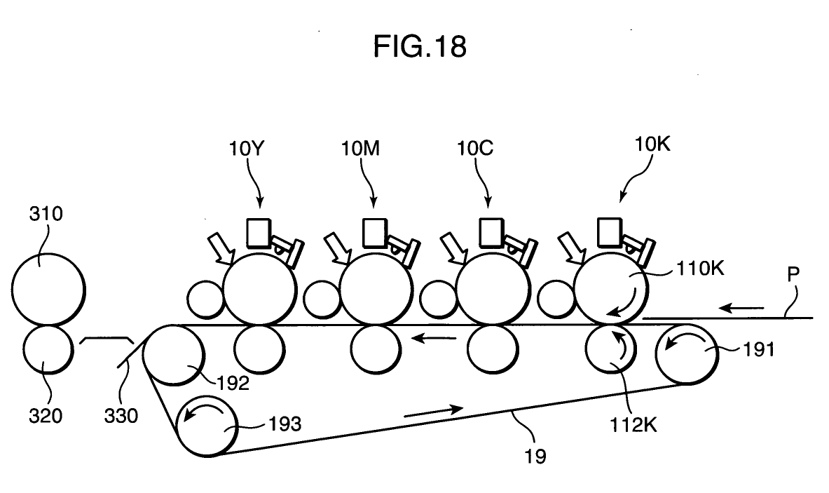

In the fixing devices 300 (400, 500) of the above embodiments are used the heat roller 310 and pressure roller 320. The present invention is also applicable to a fixing device of the type in which a heating roller 62 internally provided with a halogen heater 61 or a like heating member is held in contact with the outer surface of the heated roller 310′ (fixing roller) as shown, for example, in FIG. 13 to conduction-heat the outer surface of the heated roller 310′. Of course, the present invention is also applicable to a fixing device adopting an induction heating method.

The present invention is also applicable to a fixing device in which a heating roller 61 internally provided with a halogen heater 61 or a like heating member is distanced from the heated roller 310′ and a conductive belt 63 is rotatably mounted between the heated roller 310′ and heating roller 62 to conduction-heat the outer surface of the heated roller 310′ as shown in FIG. 14 or to a fixing device in which a fixing belt 64 is substituted for the heat roller 310 and a heating element 65 held in contact with the inner wall surface of the fixing belt 64 is disposed to directly heat the fixing belt 64 as shown in FIG. 15.

Further, the present invention may be applied to a fixing device in which a pressing unit 320A comprised of a pair of rollers 321, 322 and a pressing endless belt 323 mounted on these rollers 321, 322 is used instead of the aforementioned pressure roller 320 as shown in FIG. 16. Alternatively, the present invention may be applied to a fixing device in which a pressing unit 320B comprised of a pressing endless belt 324 and a pressing pad 325 is used instead of the pressure roller 320 as shown in FIG. 17.

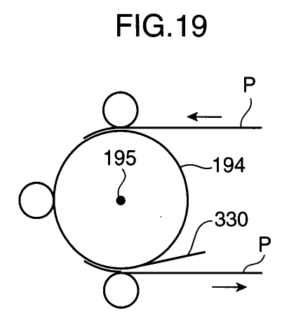

In the above embodiments, the present invention is applied to the fixing devices. Besides, the present invention is also applicable to various sheet conveying devices. For example, FIG. 18 shows a sheet conveying device in an image forming assembly of a tandem color printer. This image forming assembly includes tandemly arranged image forming units of the respective colors, i.e. a yellow unit 10Y, a magenta unit 10M, a cyan unit 10C and a black unit 10K, and a conveyor belt 19 turning via nips between photoconductive drums (110K) of the respective units and transfer rollers (112K).

The conveyer belt 19 is mounted on a plurality of rollers 191, 192 and 193 and conveys a sheet P while electrostatically attracting the sheet P to the outer circumferential surface thereof. Toner images of the respective colors formed by the image forming units of the respective colors are successively superimposed on the sheet P. Thereafter, the sheet P having a color toner image formed thereon is introduced to a nip portion between a heat roller 310 and a pressure roller 320 for a fixing process.

A separating claw 330 extends toward the outer circumferential surface of the conveyor belt 141 at an entrance side position of the pair of fixing rollers. Here, the separating claw 330 functions to separate the sheet P electrostatically attracted to the outer circumferential surface of the conveyor belt 19 and reliably introduce the sheet P to the pair of fixing rollers.

FIG. 19 shows a sheet conveying device using a large-diameter conveyor roller 194 rotating about a shaft center 195, as another example of the sheet conveying device. Here, a sheet P is conveyed to turn a conveying direction thereof by 180° while being held in close contact with the outer circumferential surface of the conveyor roller 194. A separating claw 330 extends toward the outer circumferential surface of such a conveyor roller 194 at a sheet exit side of the conveyor roller 194.

In such a sheet conveying device, the sheet P is likely to wind around the conveyor roller 194 in the case where the sheet P being conveyed is a thin sheet or the like having weak elasticity. The separating claw 330 prevents such winding of the sheet P and contributes to the realization of smooth conveyance of the sheet P.

### INDUSTRIAL APPLICABILITY

The fixing device, image forming apparatus and sheet conveying device according to the present invention enable easy assembling and exchange of the separating claws and make the separating claws difficult to detach, and are useful as a fixing device, a sheet conveying device and an image forming apparatus such as a copier, printer or facsimile machine.

The specific embodiments described above mainly embrace inventions having the following constructions.

A fixing device according to one aspect of the present invention comprises a heating rotator for heating a transfer material; a pressurizing rotator held in contact with the heating rotator at a specified pressure to form a nip portion; a separating member made of a plate-like elastic body and adapted to separate the transfer material discharged from the nip portion from the heating rotator and/or pressurizing rotator; and a separating-member holder for positioning and holding the separating member at a discharge side of the nip portion, wherein the separating-member holder holds the separating member utilizing a repulsive force resulting from an elastic deformation with the separating member elastically deformed.

Another aspect of the present invention is directed to an image forming apparatus, comprising a photoconductive member; an exposure unit for forming an electrostatic latent image on the photoconductive member; a development unit for forming a developer image by attaching a developer to the electrostatic latent image; a transfer unit for transferring the developer image to a transfer material; and a fixing unit for fixing the developer image to the transfer material, wherein the fixing unit has the construction of the above fixing device.

With this construction, the separating member can be attached to the fixing device utilizing the repulsive force resulting from the elastic deformation of the separating member without using screws or adhesive. Accordingly, the number of parts used to attach the separating member to the fixing device can be reduced, and the separating member can be easily attached. Thus, there can be provided a fixing device or an image forming apparatus in which the separating member can be easily assembled and exchanged while being made difficult to detach.

In the above construction, the separating-member holder preferably holds the separating member in an arched state. With this construction, the repulsive force can be efficiently generated.

In this case, it is preferable that the separating member includes a first end faced toward the nip portion and a second end located at a side opposite to the first end; and that the separating-member holder includes a first receiving portion on which the second end biased with the repulsive force resulting from the elastic deformation of the arched separating member rests.

In this construction, the first end of the separating member can be supported on the outer surface of the heating rotator or pressurizing rotator with the repulsive force resulting from the elastic deformation of the arched separating member.

Alternatively, a second receiving portion may be further provided which supports the first end biased with the repulsive force resulting from the elastic deformation of the arched separating member.

In the above construction, it is preferable that the separating member includes a first end faced toward the nip portion, a second end located at a side opposite to the first end and a through hole provided between the first and second ends; and that the separating-member holder is for holding the separating member in an arched state by bringing the first end of the separating member into contact with the heating rotator or pressurizing rotator with a specified pressing force and includes an insertion space into which the second end of the separating member is insertable and a projection fittable into the through hole of the separating member to determine the mount position of the separating member.

According to this construction, the separating member is held in the arched state by the separating-member holder while the first end of the separating member is supported on the heating rotator or pressurizing rotator and the second end is supported in the insertion space of the separating-member holder. By the engagement of the projection and through hole, the positioning of the separating member is realized. Accordingly, the separating member can be easily assembled and exchanged while being made difficult to detach.

In this case, the separating-member holder preferably includes a pressing-force adjusting portion for adjusting the pressing force of the separating member against the heating rotator or pressurizing rotator by pressing a part of the separating member between the through hole and first end toward the heating rotator or pressurizing rotator.

In the above construction, it is preferable that the separating member includes a first end faced toward the nip portion, a second end located at a side opposite to the first end and a through hole provided between the first and second ends; and that the separating-member holder is for holding the separating member in an arched state without bringing the first end of the separating member into contact with the heating rotator or pressurizing rotator and includes an insertion space into which the second end of the separating member is insertable, a projection fittable into the through hole of the separating member to determine the mount position of the separating member and a restricting portion for preventing the first end from coming into contact with the heating rotator or pressurizing rotator by pressing a part of the separating member between the through hole and first end.

According to this construction, the separating member is held in the arched state by the separating-member holder while the first end of the separating member is supported by the restricting portion and the second end is supported in the insertion space. By the engagement of the projection and through hole, the positioning of the separating member is realized. Accordingly, the separating member can be easily assembled and exchanged while being made difficult to detach.

In the above construction, two or more separating members are preferably provided and arranged in such a way that their respective longitudinal axes are in parallel with a discharging direction of the transfer material at the discharge side.

Alternatively, the separating member may include a first end faced toward the nip portion, a second end located at a side opposite to the first end and a through hole provided between the first and second ends, the width of the separating member may conform to that of the transfer material, and two or more through holes may be provided in a direction of the width.

According to these constructions, separation can be precisely performed in accordance with the size of the transfer material.

In the above construction, the separating member preferably includes a base member made of a stainless-steel plate and a fluororesin layer formed on the outer surface of the base member.

In the above construction, it is preferable that a holding frame for rotatably holding the heating rotator and/or pressurizing rotator is further provided, and that the separating-member holder is assembled into the holding frame.

A sheet conveying device according to still another aspect of the present invention comprises a conveyor member having a rotatable conveying surface capable of conveying a sheet while being held in close contact therewith; a separating member made of an elastic body and adapted to separate the sheet from the conveying surface; and a separating-member holder for positioning and holding the separating member at a sheet discharging side, wherein the separating-member holder holds the separating member utilizing a repulsive force resulting from an elastic deformation with the separating member elastically deformed.

In this case, the conveyor member is preferably a conveyor belt that turns while being mounted on a plurality of rollers or preferably a conveyor roller rotatable about a shaft center.

This application is based on patent application No. 2006-234143 filed in Japan, the contents of which are hereby incorporated by references.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. A fixing device, comprising:
a heating rotator for heating a transfer material;
a pressurizing rotator held in contact with the heating rotator at a specified pressure to form a nip portion;
a separating member made of a plate-like elastic body and adapted to separate the transfer material discharged from the nip portion from the heating rotator and/or pressurizing rotator; and
a separating-member holder for positioning and holding the separating member at a discharge side of the nip portion,
wherein the separating-member holder holds the separating member utilizing a repulsive force resulting from an elastic deformation with the separating member elastically deformed.

2. A fixing device according to claim 1, wherein the separating-member holder holds the separating member in an arched state.

3. A fixing device according to claim 2, wherein:
the separating member includes a first end faced toward the nip portion and a second end located at a side opposite to the first end, and
the separating-member holder includes a first receiving portion on which the second end biased with the repulsive force resulting from the elastic deformation of the arched separating member rests.

4. A fixing device according to claim 3, wherein the first end of the separating member is supported on the outer surface of the heating rotator or pressurizing rotator with the repulsive force resulting from the elastic deformation of the arched separating member.

5. A fixing device according to claim 3, wherein:
the separating-member holder further includes a second receiving portion for supporting the first end biased with the repulsive force resulting from the elastic deformation of the arched separating member.

6. A fixing device according to claim 1, wherein:
the separating member includes a first end faced toward the nip portion, a second end located at a side opposite to the first end and a through hole provided between the first and second ends; and
the separating-member holder is for holding the separating member in an arched state by bringing the first end of the separating member into contact with the heating rotator or pressurizing rotator with a specified pressing force and includes an insertion space into which the second end of the separating member is insertable and a projection fittable into the through hole of the separating member to determine the mount position of the separating member.

7. A fixing device according to claim 6, wherein the separating-member holder includes a pressing-force adjusting portion for adjusting the pressing force of the separating member against the heating rotator or pressurizing rotator by pressing a part of the separating member between the through hole and first end toward the heating rotator or pressurizing rotator.

8. A fixing device according to claim 1, wherein:
the separating member includes a first end faced toward the nip portion, a second end located at a side opposite to the first end and a through hole provided between the first and second ends; and
the separating-member holder is for holding the separating member in an arched state without bringing the first end of the separating member into contact with the heating rotator or pressurizing rotator and includes an insertion space into which the second end of the separating member is insertable, a projection fittable into the through hole of the separating member to determine the mount position of the separating member and a restricting portion for preventing the first end from coming into contact with the heating rotator or pressurizing rotator by pressing a part of the separating member between the through hole and first end.

9. A fixing device according to claim 1, wherein two or more separating members are provided and arranged in such a way that their respective longitudinal axes are in parallel with a discharging direction of the transfer material at the discharge side.

10. A fixing device according to claim 1, wherein:
the separating member includes a first end faced toward the nip portion, a second end located at a side opposite to the first end and a through hole provided between the first and second ends;
the width of the separating member conforms to that of the transfer material; and
two or more through holes are provided in a direction of the width.

11. A fixing device according to claim 1, wherein the separating member includes a base member made of a stainless-steel plate and a fluororesin layer formed on the outer surface of the base member.

12. A fixing device according to claim 1, further comprising a holding frame for rotatably holding the heating rotator and/or pressurizing rotator, wherein the separating-member holder is assembled into the holding frame.

13. An image forming apparatus, comprising:
a photoconductive member,
an exposure unit for forming an electrostatic latent image on the photoconductive member,
a development unit for forming a developer image by attaching a developer to the electrostatic latent image,
a transfer unit for transferring the developer image to a transfer material, and
a fixing unit for fixing the developer image to the transfer material, wherein:
the fixing unit includes
a heating rotator for heating a transfer material;
a pressurizing rotator held in contact with the heating rotator at a specified pressure to form a nip portion;
a separating member made of a plate-like elastic body and adapted to separate the transfer material discharged from the nip portion from the heating rotator and/or pressurizing rotator; and
a separating-member holder for positioning and holding the separating member at a discharge side of the nip portion,
wherein the separating-member holder holds the separating member utilizing a repulsive force resulting from an elastic deformation with the separating member elastically deformed.

14. An image forming apparatus according to claim 13, wherein:
the separating member includes a first end faced toward the nip portion, a second end located at a side opposite to the first end and a through hole provided between the first and second ends; and
the separating-member holder is for holding the separating member in an arched state by bringing the first end of the separating member into contact with the heating rotator or pressurizing rotator with a specified pressing force and includes an insertion space into which the second end of the separating member is insertable and a projection fittable into the through hole of the separating member to determine the mount position of the separating member.

15. An image forming apparatus according to claim 14, wherein the separating-member holder includes a pressing-force adjusting portion for adjusting the pressing force of the separating member against the heating rotator or pressurizing rotator by pressing a part of the separating member between the through hole and first end toward the heating rotator or pressurizing rotator.

16. An image forming apparatus according to claim 13, wherein:
the separating member includes a first end faced toward the nip portion, a second end located at a side opposite to the first end and a through hole provided between the first and second ends; and
the separating-member holder is for holding the separating member in an arched state without bringing the first end of the separating member into contact with the heating rotator or pressurizing rotator and includes an insertion space into which the second end of the separating member is insertable, a projection fittable into the through hole of the separating member to determine the mount position of the separating member and a restricting portion for preventing the first end from coming into contact with the heating rotator or pressurizing rotator by pressing a part of the separating member between the through hole and first end.

17. An image forming apparatus according to claim 13, wherein two or more separating members are provided and arranged in such a way that their respective longitudinal axes are in parallel with a discharging direction of the transfer material at the discharge side.

18. An image forming apparatus according to claim 13, wherein:
the separating member includes a first end faced toward the nip portion, a second end located at a side opposite to the first end and a through hole provided between the first and second ends;
the width of the separating member conforms to that of the transfer material; and
two or more through holes are provided in a direction of the width.

19. An image forming apparatus according to claim 13, wherein the separating member includes a base member made of a stainless-steel plate and a fluororesin layer formed on the outer surface of the base member.

20. A sheet conveying device, comprising:
a conveyor member having a rotatable conveying surface capable of conveying a sheet while being held in close contact therewith;
a separating member made of an elastic body and adapted to separate the sheet from the conveying surface; and
a separating-member holder for positioning and holding the separating member at a sheet discharging side,
wherein the separating-member holder holds the separating member utilizing a repulsive force resulting from an elastic deformation with the separating member elastically deformed.

21. A sheet conveying device according to claim 20, wherein the conveyor member is a conveyor belt that turns while being mounted on a plurality of rollers.

22. A sheet conveying device according to claim 20, wherein the conveyor member is a conveyor roller rotatable about a shaft center.
